(19) United States
(12) Patent Application Publication
(10) Pub. No.: US 2016/0188351 A1
(43) Pub. Date: Jun. 30, 2016

(54) PROCESS FOR PROVIDING INCREASED POWER ON DEMAND IN A COMPUTER PROCESSING SYSTEM WITH SUBMODELING

(71) Applicant: BULL HN INFORMATION SYSTEMS, INC.

(72) Inventors: SIDNEY L. ANDRESS, GLENDALE, AZ (US); BRUCE A. NOYES, PHOENIX, AZ (US); RUSSELL W. GUENTHNER, GLENDALE, AZ (US)

(21) Appl. No.: 14/582,285

(22) Filed: Dec. 24, 2014

(51) Int. Cl. G06F 9/455

(52) U.S. Cl. CPC G06F 9/45508

(57) ABSTRACT

A method is disclosed for providing added central processing power upon specific request in a processing system with an emulated processing unit, the method having further advantage by providing the additional processing power without a reboot of the operating system. The method also provides for a billing mechanism providing for increased charges for the added processing power.

### RELATED APPLICATIONS

REFERENCE TO US PATENT 2007/0157050 filed Mar. 6, 2007, publication date Jul. 5, 2007

INCORPORATION BY REFERENCE TO U.S. PROVISIONAL PATENT APPLICATION 61/921,133 filed Dec. 27, 2013

### STATEMENT REGARDING FEDERALLY SPONSORED RESEARCH OR DEVELOPMENT

NONE

### THE NAMES OF PARTIES TO A JOINT RESEARCH AGREEMENT

NONE

### INCORPORATION-BY-REFERENCE OF MATERIAL SUBMITTED ON A COMPACT DISC

NONE

This application claims priority to a U.S. Provisional Patent Application 61/921,133 filed Dec. 27, 2013 titled “PROCESS FOR PROVIDING INCREASED POWER ON DEMAND IN A COMPUTER PROCESSING SYSTEM WITH SUBMODELING” with first named inventor Sid Andress, Phoenix, Ariz. (US), which is expressly incorporated herein as though set forth in full.

### BACKGROUND OF THE INVENTION

This invention relates to the art of computer systems and, more particularly, to a process for controlling level of submodel performance in a computer processing unit.

In the delivery of computer processing power to customers or end users, it is sometimes desirable to offer a processing unit with a controlled level of performance that is less than the highest level of performance that could be achieved. For example, in the mainframe computing industry, the price charged for a processing unit is often directly related to performance, and so reducing the maximum allowable performance of a delivered unit allows the manufacturer to deliver a product at a controlled level of performance and to charge the customer a lower price than would be offered for a unit that would deliver maximum performance. This practice is common and fully accepted in the computer industry.

In a complex computer system, achieving accurate degradation of performance in a precisely controlled manner to obtain a certifiable submodel rating is a not trivial task. The problem is made complex by many factors. Some examples of these factors are:
1) Instructions in a processor, whether implemented in hardware or in a software emulation, may not require the same amount of time for execution.
2) In a software emulation, or in the firmware to control a hardware based central processing unit, instructions used to control and perform the emulation of a processor may themselves not execute in the same amount of time each time they are executed.
3) The same series of instructions, when executed multiple times, may vary, sometimes widely, in the amount of time required to complete either single instructions or a series of instructions. This can be caused either by direct factors such as cache miss or by indirect causes such as bus interference from other programs running on another processor.
4) In offering a submodel, it is desirable to both the customer and the manufacturer that the degradation of performance appear to the end user as being smoothly applied across all elements of a program, not appearing as though one element performs at a high speed and another unit at a degraded, compensating, low speed.
5) The degradation of a processor should allow for achievement of a wide range of degradation without changes in the basic procedure or complex measurements to achieve the selected level of degradation.
6) The time required to sample an interval of time in a processor performing an emulation does not in itself take zero time, so this is a subtle factor in both choosing and implementing the procedure for degradation.

It is key to provide a procedure which is highly accurate in establishing a processor's submodel performance. It is also key to provide a procedure that is relatively simple and which itself constitutes a negligible load on system performance.

These objectives are achieved in the prior art by: sampling a real-time counter/clock (RTC) to obtain an initial time value T1; resetting an Icnt Counter; incrementing the Icnt Counter to reflect the processing of each instruction; comparing the count in the Icnt Counter to a predetermined count IcntMax and if the count in the Icnt Counter is at least IcntMax, then sampling the RTC to obtain a second time T2. T1 is then subtracted from T2 to obtain a time difference DT which is multiplied by ((1−1/DF)−1) to obtain a Degradation Delay DD period, DF being a degradation factor which is a constant having a value that is the ratio of the desired submodel performance with respect to full performance. The Degradation Delay is instituted by sampling the RTC from time to time to obtain a test third time T3. When test T3 minus T2 exceeds or equals DD, then T1 is set to the current value for T3, and the procedure is repeated for a next group of instructions. Further accuracy is achieved by remembering the difference between the quantity T3 minus T2, and DD which is saved as DDExtra. DDExtra is the amount of time larger than DD that has been delayed during a given pass through the process, and for further precision may be used during the next group of instructions to reduce the delay time; that is, the applied delay for this next group is DD minus DDExtra from the previous group of instructions.

It is noted that the incrementing of the Icnt Counter and the comparison against the number IcntMax is a mechanism intended to trigger the periodic reading of the RTC. The reading of the RTC in most processors takes time which would significantly slow the processing, or the emulation if it was done during the processing of every instruction, which would be unacceptable with respect to overall performance. The incrementing of the Icnt Counter is intended to be a function of trivial performance impact, and this is all that happens in the normal case. When Icnt reaches IcntMax, then the time for the reading of RTC is reached, but since this determination is only made occasionally, it constitutes low overhead with greatly reduced impact on performance (IcntMax is large, for example 100 to 10000, or more).

It is further noted that the method described above of using an Icnt Counter and comparison of Icnt to IcntMax is for exemplary purposes only, and any mechanism which causes or allows only substantially periodic sampling of the RTC could be used.

In the repertoire of instructions for many processing units, there are instructions which allow delay, or which themselves read or use the RTC in some way. Precise degradation of performance for submodel offerings may optionally, for further accuracy, be achieved by considering and treating “wait-type” and/or “RTC-access-type” instructions specially.

“Wait” instructions tell the processor to stop and simply wait for something to do such as wait for an input/output operation to complete. This internal (to the instruction) waiting is completed when some external event, such as an interrupt, occurs or when some specified amount of delay is achieved. For “wait-type” instructions, best precision of delay is achieved if the internal wait loop is not entered until the Degradation Delay procedure as described above is immediately processed, just as though IcntMax had been reached. If the external event occurs, the internal wait loop is exited, and the Degradation Delay is truncated.

A second refinement particularly applicable to an emulated or firmware controlled processor is that when the processor desires to read any RTC (“RTC-access-type” instruction) for other purposes than degradation, then the Degradation Delay procedure is applied before the RTC to which the processor is referring is sampled so that processing of two back-to-back “read RTC” instructions will not be completed in an unnaturally small amount of time; “unnatural” in this context meaning as though the instructions were running in a full performance version of the processor emulation.

### BRIEF SUMMARY OF THE INVENTION

Customers whose workload level has reached the point where a computer processing site needs additional CPU Power for a short period of time to complete desired processing have been given very few options. They can add an additional processors to their system to meet requirements during a short period of high workload levels, but this is costly and the extra processor and/or processing power is unused most of the time. Typically computer processing sites that are in this situation are smaller sites running sub-model system where adding significant numbers of additional processors is not an economical answer to their processing needs.

To address these needs one approach in the manner of the present invention is to increase the CPU Power of the processors by upping the emulated processor speed dynamically for a period of time that meets the customer needs for higher CPU Power. Implementaiton of this approach is not straightforward however because the performance of a submodel processing unit is typically tightly secured and also typically requires a reboot of the operating system with security reequirements such as entering a key to enable a higher level of processing power.

The need is for increased processing power available on specific request and it would be advantageous to provide the ability for a site to dynamically increase their processor speed whenever administrators of the site feel the need the extra power and also are willing to pay for the additional processor speed. Once the site has completed the high workload they either dynamically or automatically return to the original CPU Power speed of the sub-model system, or they make a request to decrease power, and resultant charges. Alternatively the initial power on request can specify a time of higher power, periods of higher power, or higher power for a specific job.

It is a further advantage to provide the ability to change the processing speed of the processors in the system without having to reboot the operating system, This speed value is typically contained in a model file used to set up the system and normally cannot be changed without causing signature file errors during a boot.

It is a further advantage to provide capability to track the speed changes of the processors in the system for monthly billing of the computer used at the higher than sub-model speed. This provides a site with the ability to control the system performance for periods of time when the workload is greater than the current sub-model speed of the system.

It is a further advantage to provide a dynamic means for customers to increase the speed of the emulated processors in their system to meet their work load and including in the process or method a mechanism for charging the customer for the time the system runs in the over system model power speed.

One approach in meeting requirements of the design in order to maintain steady and precise emulated performance is to update a reserved memory word (RMS) with the new processor speed value. This word is then routinely checked by the Processor Emulation code and will result in dynamically changing the emulated speed of the emulated processors in the system when the value changes.

In one manner of the present invention, the operating system provides new console commands to manage the emulated processor speed. The code validates that the site has this option when a console request is entered. Once the console request is determined valid, the emulated performance of the processor is increased so as to provide added processor speed. A record is also optionally written to the system accounting file to provide tracking of the CPU Power change.

It is also advantageous to provide a periodic automated call to the billing department of the computer system provider to allow for billing of the increased CPU power, for example at the start of each month.

In an alternative implementation the increase in power can be requested with control cards in the job control language provided by the computer system operating system, optionally with a password to limit requests to those with the authorization to incur the billing charges.

It is a further optional key advantage to provide for the processor change in performance (speed) in a manner that avoids need for a reboot of the operating system. This is possible in a manner different than the prior art by implementing the degradation parameters of the emulation system in a reserved memory word that is not available to users, that is, only available or accessible (changeable) by the operating system. A very efficient mechanism is required for access by the emulation firmware because this degradation parameter is accessed very frequently and this access must not lower overall emulation performance too dramatically. One alternative that accomplishes efficient access to the degradation parameter is to store a degradation parameter in memory that is commonly accessible and shared between the emulation firmware and the operating system. This can be an agreed upon location in reserved memory. Another alternative is to have the degradation parameter stored in memory or a register only accessible to the emulation firmware, and then for the emulation firmware to provide instructions or other interface to the operating system that would alter those degradation parameters.

### BRIEF DESCRIPTION OF THE SEVERAL VIEWS OF THE DRAWINGS

FIG. 1 provides a flow chart of the user visible commands and underlying operating system action to control power on request features in a manner of one illustrated embodiment of the present invention; and,

FIG. 2 is an illustration of control components and their interaction in an illustrated embodiment of the present invention.

### DETAILED DESCRIPTION OF THE INVENTION

The above is an overview of several embodiments implementing the method of the present invention and provides exemplary examples utilizing selected aspects described in connection with certain embodiments of the present invention.

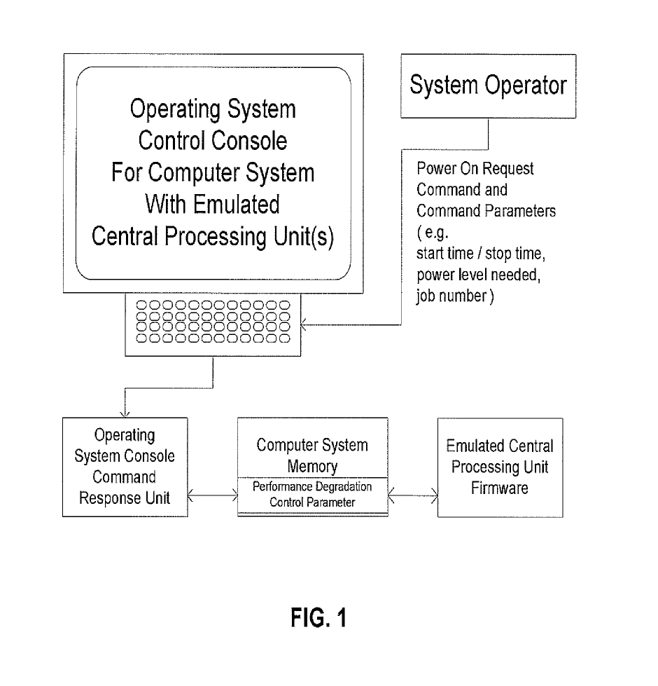

FIG. 1 provides illustration of an emulated computer system running within a larger computer system. The “larger” computer system is for example a system such as a Linux system, and the emulated computer system is a system such as an emulated Bull GCOS8 system. The emulation in this example is at the level of a central processing unit with emulation software/firmware loaded into memory of the larger computer system as a controlling emulation program. The emulation software provides an emulation at an instruction by instruction level of processing performed by an emulated central processing unit such as a Bull GCOS8 central processing unit. The emulation software includes software providing for running of the emulation at a plurality of performance levels, for example at a plurality of instruction rates. The performance can be limited in various ways that could be devised by one knowledgeable in the art of emulation processor software. The price or charge for use of the emulated computer system depends on a selected level of performance, and limitations on the performance are typically provided by a software key designed and/or provided by the manufacturer of the emulation software or the emulated computer system.

A user may find need for a submodel level of performance during most normal periods of time, but with a need for higher processing performance at other times. The present invention provides a means for a user to request higher performance while the emulation software is continuously running (without stopping the emulated computer system). A requirement to stop an emulated computer system in order to change its performance would be a severe operational disadvantage in a large computer system installation. In FIG. 1 an operating system console 100 is shown on which an operator 110 or user types a command 150 or in some way issues instructions to the emulated computer system communicating a desire to change performance of the emulated system. The power on request command 150 typically provides parameters such as, for example, the amount of additional performance requested, and, the time period during which the additional performance is requested. The power on request parameters could also just be an implied turning on, turning off, or toggling of a change in performance level. A power system response portion 120 of the emulation system receives this command and responds by writing into one or more special memory locations 130 which are accessible to the emulated central processor software/firmware 140. This memory location is utilized regularly by the emulation processing software to control performance. That is, changing this specific memory location will results in an immediate, or fairly immediate change in performance of the emulation software. (What is meant by “immediate” or “fairly immediate” is that the emulation software will check this location frequently enough that changing the location will take effect quickly. That is, the location is checked for example every second or two, or at the start of every job, or at the start of every activity, or at some interval frequently enough that it has effect on jobs launched after the command is issued).

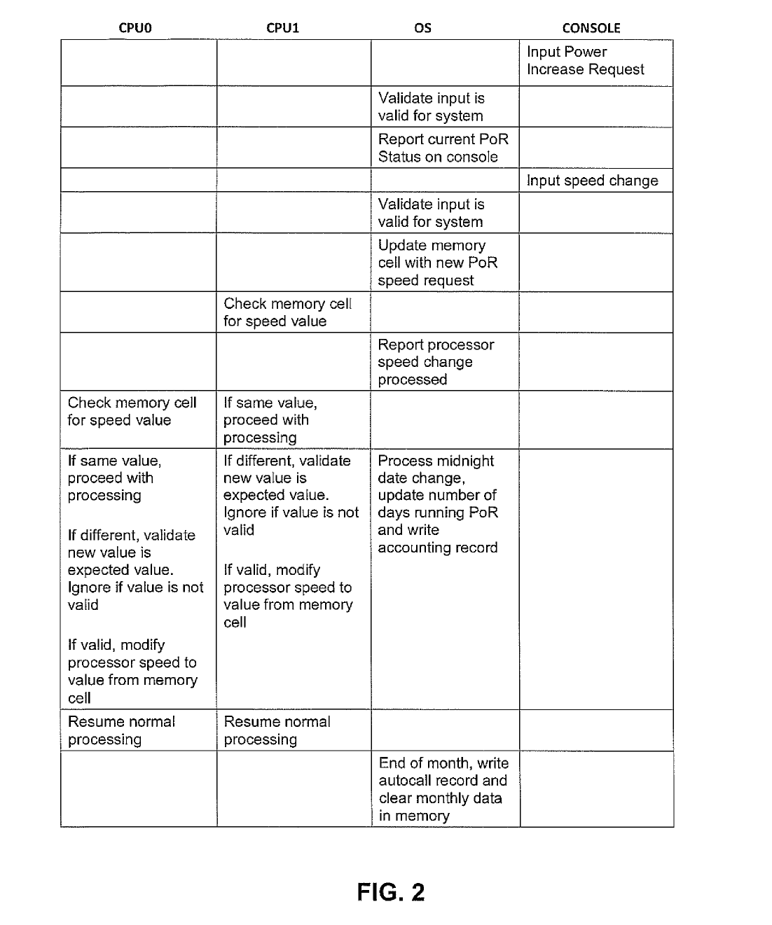

FIG. 2 provides finther illustration of an exemplary process in the manner of the present invention with multiple emulated processors CPU0 200 and CPU1 201. Multiple emulated processors would typically be implemented with a thread process of processing for each emulated processor, the threads or processes running independently of each other. A power on demand request is made at a computer console 203 or user terminal and a memory location is utilized to communicate the desired performance to the emulation software. The memory cell or cells that are checked by the emulated processor threads may be either shared by the multiple threads, or there may be a memory cell for each emulated processor. In either case, the emulation software for each processor checks 210 the memory cell periodically and then determines if the memory cell value is a valid setting, typic based upon a software key 212 and if valid and if the value has changed 211 the processor speed is modified 213 and normal process is resumed 214 at the new processing rate. The emulated operating system 202 may also validate the requests for performance modification and track such changes 220 for accounting and billing purposes.

Other aspects of the present invention not explicitly described herein can be derived after presentation of the concepts of the present invention as here presented without departing from practice of this invention. Those derivations may be made by someone knowledgeable in the art of communications, computer programming, caching of data and other similar skills. Having described the preferred embodiments of the invention, it will now become apparent to one skilled in the arts that other embodiments or implementations incorporating the teachings of the present invention may be used. Accordingly, these embodiments should not be limited to the disclosed embodiments or implementations but rather should be limited only by the spirit and scope of the following claims.

What is claimed is:

1) A process for altering performance of a computer system utilizing an emulated processor controlled by emulation firmware/software, the emulated processor processing instructions and running with a normal submodel performance comprising the steps of:
A. Receiving from a user of the computer system a power alteration command;
B. As a result of receiving the power alteration command, writing a performance control value into an emulation control location in memory, the emulation control location being accessible to the emulation firmware of the emulated processor;
C. The emulation firmware reading the emulation control location and, as a direct result of the performance control value, processing instructions at a higher performance than the normal submodel performance;
E. Utilizing the recorded power alteration request parameters for accounting purposes to increase charges for the computer system.

2) The process of claim 1 wherein the writing of the performance control value occurs while the emulation control program is running.

3) A process for providing increased performance on demand for a computer system comprising an emulated central processing unit, the emulated central processing unit controlled by an emulation control program emulating instruction execution of the emulated central processing unit and being configurable to provide for a submodel level of performance, the process comprising the steps of:
A. Receiving from a user of the computer system a power alteration command and power alteration request parameters;
B. As a result of receiving the power alteration command, writing a performance control value into an emulation performance control location in memory accessible to the emulation control program;
C. The emulation control program reading the emulation performance control location and, as a direct result of the performance control value, processing instructions at a modified level of performance; and,
D. Recording, for accounting purposes, the power alteration request parameters and as a result increasing charges for the computer system.

4) The process of claim 3 wherein the writing of the performance control value occurs while the emulation control program is running.

5) A process for providing modified performance on demand for a computer system comprising an emulated central processing unit, the emulated central processing unit controlled by an emulation control program emulating instruction execution of the emulated central processing unit and being configurable to provide for a plurality of performance levels, the process comprising the steps of:
A. Receiving from a user of the computer system a power alteration command and power alteration request parameters;
B. As a result of receiving the power alteration command, writing a performance control value into an emulation performance control location in memory accessible to the emulation control program;
C. The emulation control program reading the emulation performance control location and, as a direct result of the performance control value, processing instructions at a modified level of performance; and,
D. Recording, for accounting purposes, the power alteration request parameters.

6) The process of claim 5 wherein the writing of the performance control value occurs while the emulation control program is running.
